(19) United States
(12) Patent Application Publication
(10) Pub. No.: US 2009/0138373 A1
(43) Pub. Date: May 28, 2009

(54) ELECTRONIC NETTING SYSTEM FOR BILATERAL TRADES

(76) Inventors: Paul Ellis, Surry (GB); Mark Rowell, London (GB); Henry Etkin, New York, NY (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 12/337,823

(22) Filed: Dec. 18, 2008

Related U.S. Application Data
(62) Division of application No. 11/192,327, filed on Jul. 28, 2005.

(51) Int. Cl. G06Q 40/00; G06Q 30/00; G06Q 99/00; G06Q 20/00

(52) U.S. Cl. 705/26; 705/37; 705/1

(57) ABSTRACT

An electronic netting system. The system includes: a plurality of individual, segregated counterparties for providing bilateral trades; and a multi-lateral transaction hub for providing an aggregation of trades between the counterparties and providing for multi-lateral netting of selected and authorized bilateral trades. In the preferred embodiment, the transaction hub includes: a trade processing system; and a netting system in communication with the trade processing system for providing for the optimized, multi-lateral netting of selected and authorized bilateral trades. Also, in the preferred embodiment, the system may further include a trading system in communication with the transaction hub.

### RELATED APPLICATIONS

This application is a divisional of U.S. application Ser. No. 11/192,327 filed Jul. 28, 2005, which is incorporated herein by reference in its entirety.

### BACKGROUND OF THE INVENTION

1. Field of the Invention

The present invention relates generally to electronic trading systems and, more particularly, to a system for multi-lateral netting of bilateral trades of OTC derivatives.

2. Description of the Prior Art

Financial derivatives are contracts of which the price/value of the contract varies with the value of an underlying instrument. Financial derivatives can either be standardized contracts traded on a recognized Exchange or OTC traded. OTC derivatives are individually negotiated and tailor-made between two counterparties (so called “over the counter (OTC) transactions”). Since the OTC contracts are individually negotiated, no objective market price exists. The parties do their own valuation of the contracts both when dealing as well as later on when establishing the market value of their contracts during their life.

Participants in the OTC markets are banks, investment banks and other financial institutions. The International Swap and Derivatives Association is a trade organization for dealers active in the OTC derivatives market. The total outstanding volume of the OTC market as a whole was estimated to be over $88 trillion dollars in 1999. An OTC derivative transaction allows the financial institution to manage its market risk positions, either for the purpose of hedging or for the purpose of deliberate position taking to make a profit from an expected change in market prices. Derivatives allow the market risk of substantial amounts to change hands without the need and associated costs of transferring the underlying values.

A thorough discussion of other aspects of OTC derivatives may be found in U.S. Published Patent Application 2003-0083978 entitled “System and method of implementing massive early terminations of long term financial contracts” by Brouwer which is hereby incorporated by reference in its entirely.

However, because of the volume of trade, it is often possible that the counterparties involved have off-setting trades which, if “ripped up” prior to the confirmation process, can result in reduction of costs to the counterparties such as upfront fees; reduction in economic and regulatory capital usage; and reduction in counterparty risk exposure. As can be appreciated, offsetting bi-lateral trades between just two counterparties is a simple process. However, offsetting or netting trades between a plurality of individual, segregated counterparties to provide for multi-lateral netting is extremely complicated.

Thus, there remains a need for a new and improved electronic netting system which provides netting of bilateral trades while, at the same time, is operable to provide optimized, multi-lateral netting among a plurality of individual, segregated counterparties.

### SUMMARY OF THE INVENTION

The present invention is directed to an electronic netting system. The system includes: a plurality of individual, segregated counterparties for providing bilateral trades; and a multi-lateral transaction hub for providing an aggregation of trades between the counterparties and providing for multi-lateral netting of selected and authorized bilateral trades. The transaction hub may include: a trade processing system; and a netting system in communication with the trade processing system for providing for the optimized, multi-lateral netting of selected, bilateral trades. In the preferred embodiment, the system may further include a trading system in communication with the transaction hub.

In the preferred embodiment, the individual, segregated counterparties may be financial institutions such as banks. The banks may include investment banks. Preferably, the bilateral trades are OTC derivatives such as credit derivatives or credit indices.

In one embodiment, the trade processing system may include an input of the bilateral trades, a database for storing the input and an output of the completed trades. The input may include the parties, the instrument, the price, the size (amount of coverage), and the fee. Preferably, the input may also include additional trade details or data from E-trading. In a preferred embodiment, the trade processing system may also include external trade input. Preferably, the output may include trade confirmations. In one embodiment, the trade processing system may also include a trade verification module. The trade verification module may be bilaterally verified.

Preferably, the netting system may include an input of trades (T₀, T, T₂, . . . T_{N}), a recursive optimization engine, and an output of netted trades. The recursive optimization engine may include a first netting interval. Preferably, the recursive optimization engine may also include at least one subsequent netting interval for netting the remainder of unnetted trades as well as previously netted trades from the preceding netting interval.

The transaction hub may also include an input of additional netting parameters. The additional netting parameters may include at least one counterparty trading limit. The output of netted trades may further include a payment output. The payments may be netted. Also, the payments may be collected by a central party. In the preferred embodiment, the output of netted trades further includes a reconciliation output.

In the preferred embodiment, the trading system is an intermediary party. Preferably, the intermediary party includes at least one voice broker. In one embodiment, the intermediary party is an E-trading system. In another embodiment, the intermediary party may include at least one voice broker and an E-trading system.

Accordingly, one aspect of the present invention is to provide an electronic netting system. The system may include: (a) a plurality of individual, segregated counterparties for providing bilateral trades, and (b) a centralized, multi-lateral transaction hub for providing an aggregation of trades between the counterparties and providing for multi-lateral netting of selected and authorized bilateral trades.

Another aspect of the present invention is to provide a multi-lateral transition hub for providing an aggregation of trades between a plurality of individual, segregated counterparties and providing for the multi-lateral netting of selected and authorized bilateral trades. The transaction hub may include: (a) a trade processing system, and (b) a netting system in communication with the trade processing system for providing for the optimized, multi-lateral netting of selected and authorized bilateral trades.

Still another aspect of the present invention is to provide an electronic netting system. The system may include: (a) a plurality of individual, segregated counterparties for providing bilateral trades, (b) a multi-lateral transaction hub for providing an aggregation of trades between the counterparties and providing for multi-lateral netting of selected and authorized bilateral trades, and (c) a trading system in communication with the transaction hub. The transaction hub may include: (i) a trade processing system; and (ii) a netting system in communication with the trade processing system for providing for the optimized, multi-lateral netting of selected and authorized bilateral trades.

These and other aspects of the present invention will become apparent to those skilled in the art after a reading of the following description of the preferred embodiment when considered with the drawings.

### BRIEF DESCRIPTION OF THE DRAWINGS

FIG. 1 is an overall block diagram of an electronic netting system constructed according to the present invention;

FIG. 2 is a schematic representation of the transaction hub shown in Figure i;

FIG. 3 is a flow chart of the main algorithm loop of the optimization engine shown in FIG. 2;

FIG. 4 is a flow chart of the optimization engine shown in FIG. 2 in recursive mode;

FIG. 5 is a flow chart of the optimization engine shown in FIG. 2 with intervals and/or remainder netting;

FIG. 6 is a flow chart of the operation of the electronic netting system shown in FIG. 1;

FIG. 7 is a screen shot of the raw data of original trades prior to multi-lateral netting of the selected and authorized bilateral trades; and

FIG. 8 is a screen shot of the output from the transaction hub following aggregation and multi-lateral netting of the selected and authorized bilateral trades.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

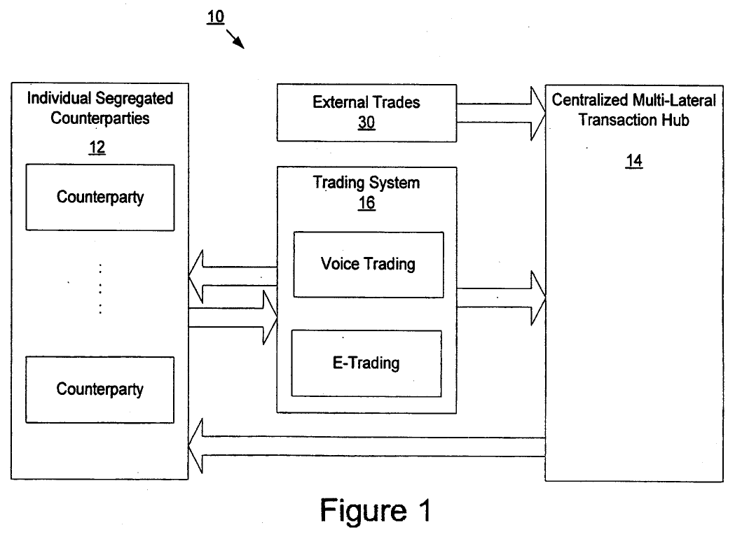

Referring now to the drawings in general and FIG. 1 in particular, it will be understood that the illustrations are for the purpose of describing a preferred embodiment of the invention and are not intended to limit the invention thereto. As best seen in FIG. 1, an electronic netting system, generally designated 10, is shown constructed according to the present invention. The electronic netting system 10 includes three components: a plurality of individual, segregated counterparties for providing bilateral trades 12; a multi-lateral transaction hub 14 for providing an aggregation of trades between the counterparties and providing for multi-lateral netting of selected and authorized bilateral trades; and a trading system 16 in communication with the transaction hub.

Preferably, the individual, segregated counterparties are financial institutions, such as banks or investment banks. Also, in the preferred embodiment the bilateral trades for OTC derivatives such as credit derivatives and most preferably credit derivatives, which are credit indices. However, other OTC derivatives assets could also be traded and netted by the present invention.

The electronic netting system 10 also includes a centralized, multi-lateral transaction hub 14 for providing an aggregation of trades between the counterparties and for providing for multi-lateral netting of selected and authorized bilateral trades. The arrangement in operation of the multi-lateral transaction hub will be discussed in more detail subsequently.

The present invention may further include a trading system 16 in communication with the transaction hub 14. In a preferred embodiment, the trading system is an intermediary party. The intermediary party may include at least one broker or an E-trading system or may include a combination of voice brokers and an E-trading system. In addition, external trades 30 may also be in communication with the multi-lateral transaction hub 14.

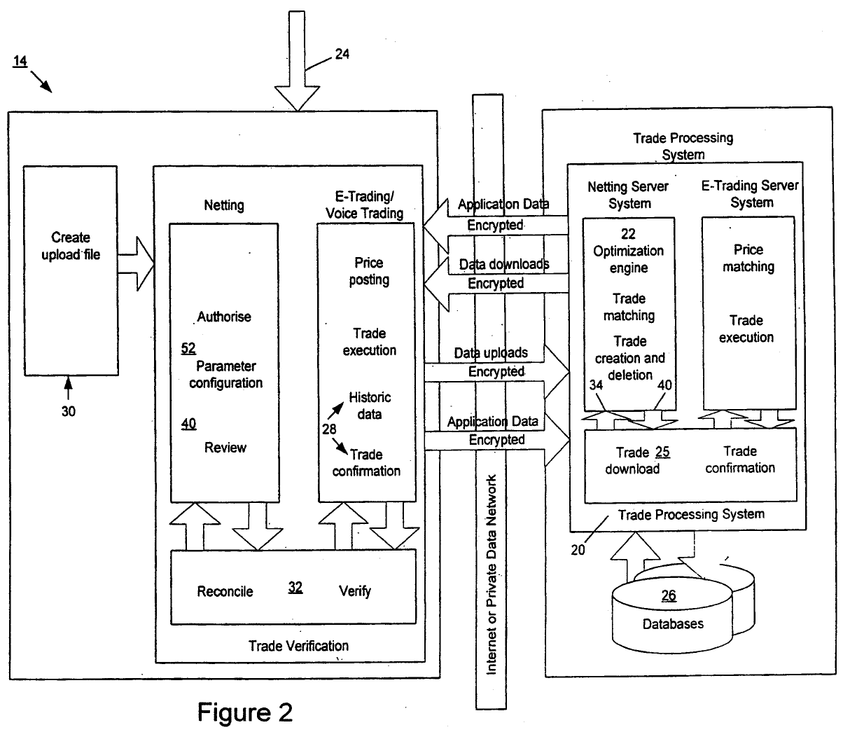

Turning now to FIG. 2, there is shown a schematic representation of the transaction hub 14 shown in FIG. 1. In the preferred embodiment, the multi-lateral transaction hub 14 includes a trade processing system 20 and a netting system 22 in communication with the trade processing system 20 for providing for the optimized, multi-lateral netting of selected and authorized bilateral trades. The trade processing system 20 includes an input 24 of the bilateral trades, a database 26 for storing the input 24, and an output 25 of the completed trades. In the preferred embodiment, the input 24 includes identification of the parties, the instrument, the price, the size, and the fee. The input 24 may further include additional trade details such as trade date, effective date, asset rank, documentation, maturity date, currency, reference obligation, day count method, date convention, payment period, and calendar region. The input 24 may also include data from E-trading or may further include external trade input. The output 25 of the trade processing system 20 may also include trade confirmations.

In the preferred embodiment, the transaction hub 14 further includes a trade verification module 32, which preferably provides for bilateral verification of the trade by both parties.

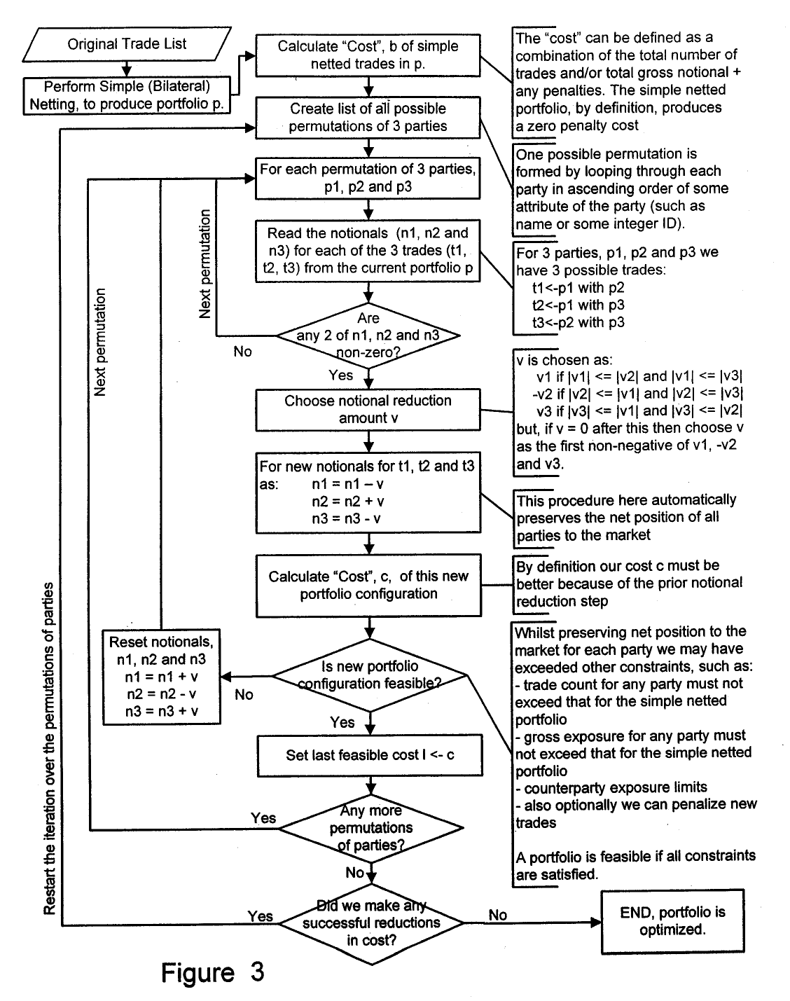

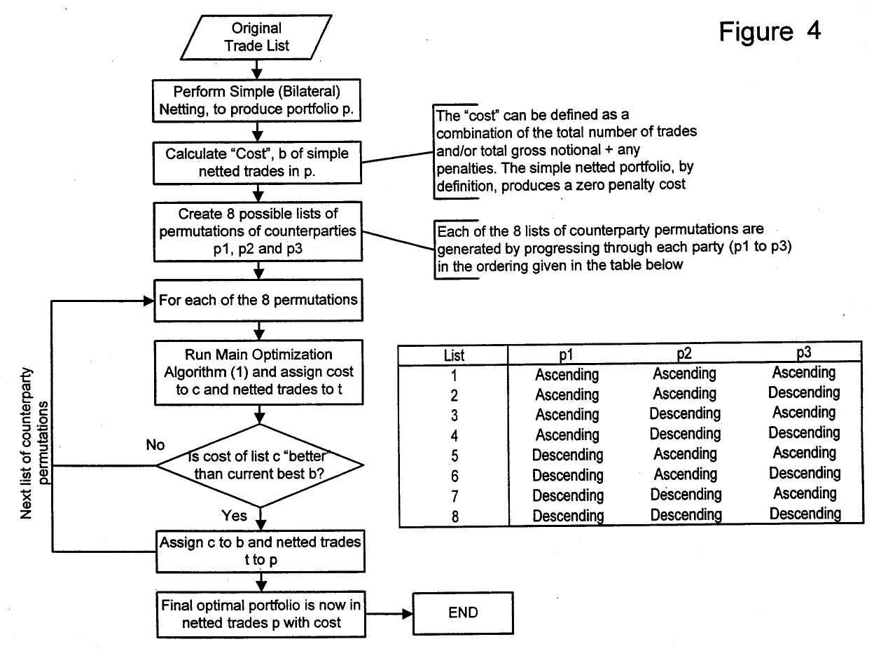

Turning to FIG. 3, there is shown a flow chart of the main algorithm loop of the optimization engine of the transaction hub shown in FIG. 2. In the preferred embodiment, the optimization engine is a recursive engine, which receives a plurality of inputs of trades and provides an output netted trades after optimization. A flow chart of the optimization shown in FIG. 2 in recursive mode is best seen in FIG. 4.

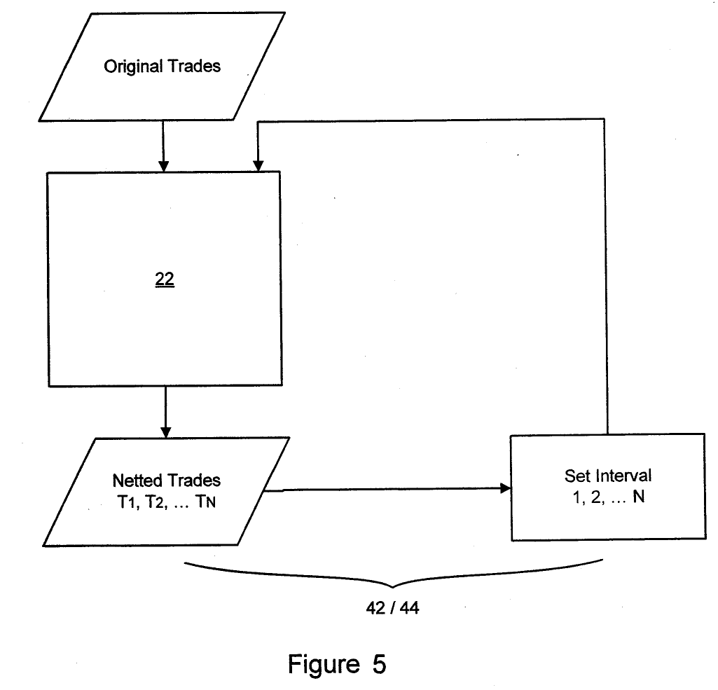

As seen in FIG. 5, the recursive optimization engine is typically run using a first netting interval, such as the end of the day. However, in the most preferred embodiment, the recursive optimization engine may further include at least one subsequent netting interval for netting the remainder of unnetted trades from the preceding netting interval. As can be appreciated, these netting intervals may be daily, weekly or monthly, depending on the assets being traded.

The netting system 22 may further include an input of additional netting parameters 52, such as having at least one counterparty trading limit. In addition, the output of netted trades 40 may further include a payment output 46. The payment output 46 may be netted or they may be collected by a central party. Finally, the netting system 22 may also further include a reconciliation output 50 of the output of netted trades 40.

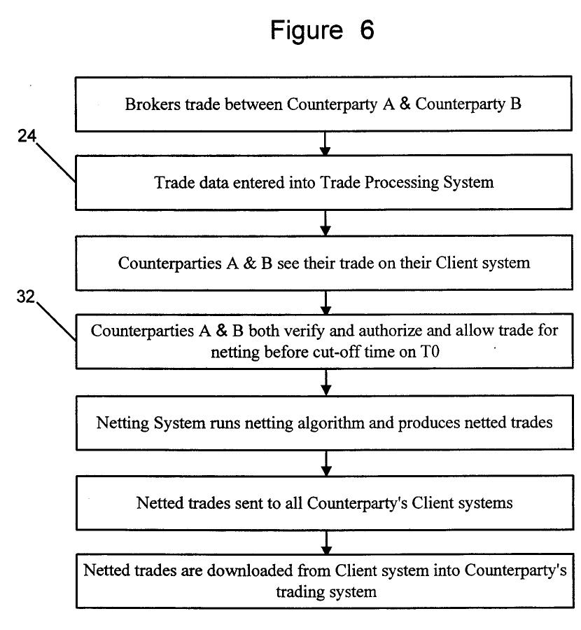

Turning to FIG. 6, there is shown a flow chart of the operation of the electronic netting system 10 shown in FIG. 1. In operation, the brokers first trade between counterparties, such as counterparty A and counterparty B, by voice trading or by E-trading or a trade is imported from an external system. Trade data is then entered into the centralized multi-lateral hub 14. The counterparties may view their trade and both counterparties may verify 32 and allow the trade for netting before the end of the pre-selected trading interval. The netting system 22 runs the optimization engine and provides the optimized multi-lateral netting of the selected and authorized bilateral trades and outputs these trades 40. The output netted trades 40 are sent to each of the counterparties are then downloaded from the electronic netting system 22 into each counterparty's trading system.

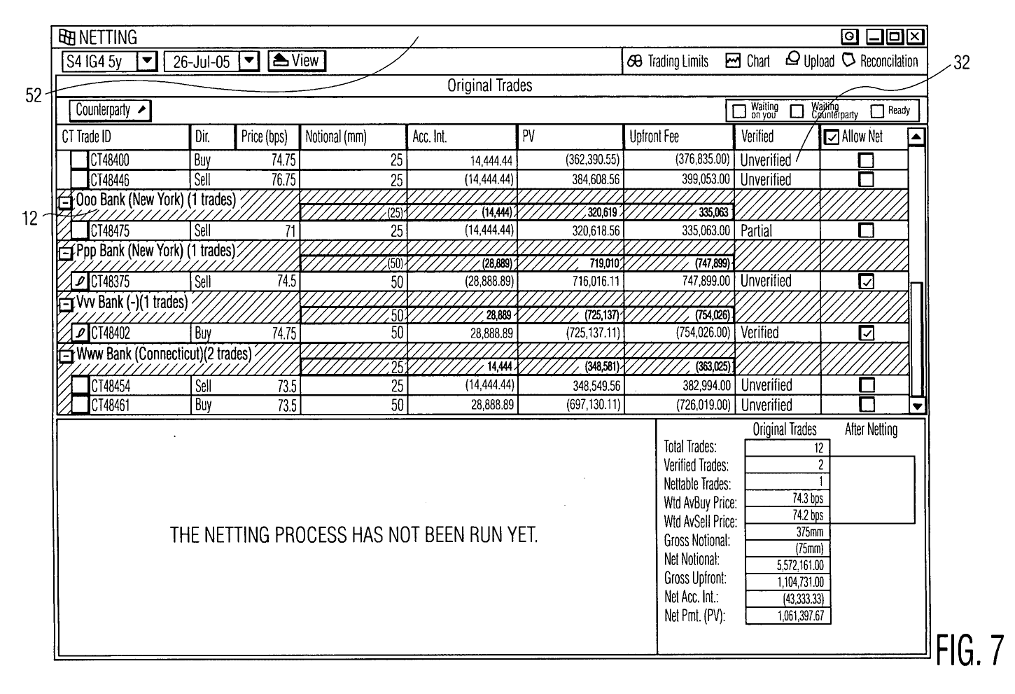

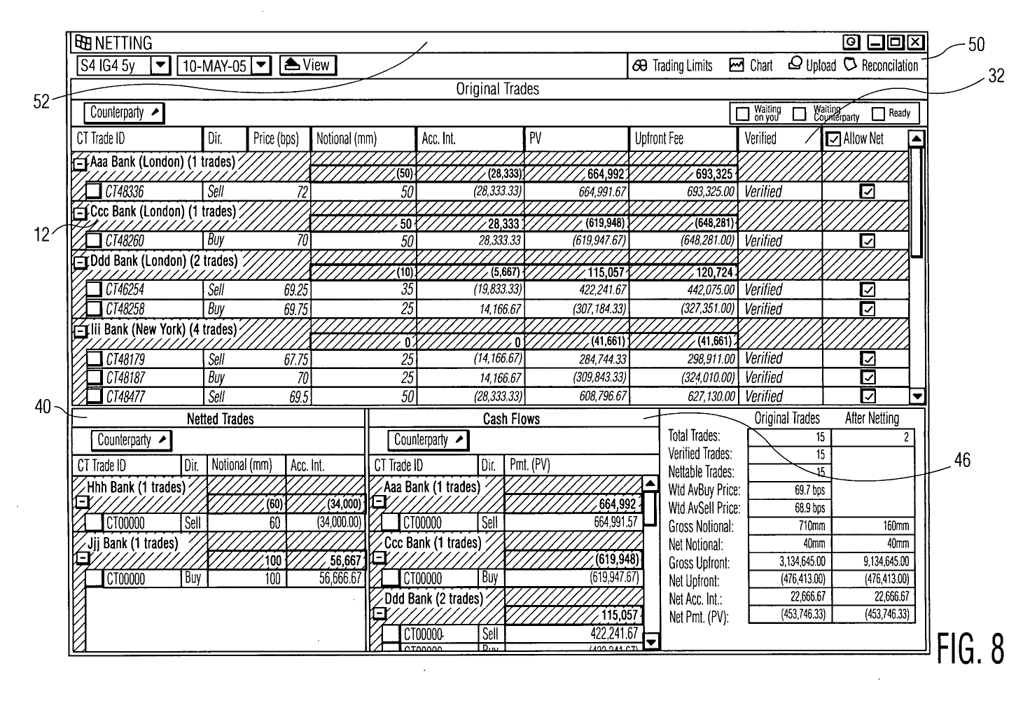

A screen shot of the raw data of the original trades prior to multi-lateral netting of the selected and authorized bilateral trades is shown in FIG. 7. Counterparties may verify 32 and authorize trades for netting. A screen shot of the output from the transaction hub 14 following aggregation and multi-lateral netting of the selected and authorized bilateral trades is shown in FIG. 8. Counterparties may view the output of netted trades 40, payments 46, and view a reconciliation 50.

Certain modifications and improvements will occur to those skilled in the art upon a reading of the foregoing description. By way of example, while a recursive algorithm is a preferred embodiment of the present invention, different algorithms may be used to provide for optimization. For example, a ‘differential evolution’ algorithm or a ‘simulated annealing’ algorithm. Also, the steps of trade verification and explicitly allowing trades for netting could potentially be omitted for some applications. Furthermore, while the transaction is centralized in a preferred embodiment of the invention, it may be decentralized. Also, while netting is preferably performed on identical instruments, netting could also be performed on similar but not identical instruments. Finally, additional netting parameters may include an indication of a counterparty's preference for reduction in number of trades versus a reduction in gross notional. It should be understood that all such modifications and improvements have been deleted herein for the sake of conciseness and readability but are properly within the scope of the following claims.

1. A multi-lateral transaction hub for providing an aggregation of trades between a plurality of individual, segregated counterparties and providing for the multi-lateral netting of selected and authorized bilateral trades, the transaction hub comprising:
a trade processing system; and
a netting system in communication with the trade processing system for providing for the optimized, multi-lateral netting of selected and authorized bilateral trades.

2. The transaction hub according to claim 1, wherein the trade processing system includes an input of the bilateral trades, a database for storing the input and an output of the completed trades.

3. The transaction hub according to claim 2, wherein the input includes the parties, the instrument, the price, the size, and the fee.

4. The transaction hub according to claim 3, wherein the input further includes additional trade details.

5. The transaction hub according to claim 2, wherein the input includes data from E-trading.

6. The transaction hub according to claim 2, further including external trade input.

7. The transaction hub according to claim 2, wherein the output includes trade confirmations.

8. The transaction hub according to claim 2, further including a trade verification module.

9. The transaction hub according to claim 8, wherein the trade verification module is bilaterally verified.

10. The transaction hub according to claim 1, wherein the netting system includes an input of trades (T₀, T|, T₂, . . . T_{N}), a recursive optimization engine, and an output of netted trades.

11. The transaction hub according to claim 10, wherein the recursive optimization engine further includes a first netting interval.

12. The transaction hub according to claim 11, wherein the recursive optimization engine further includes at least one subsequent netting interval for netting the remainder of unnetted trades from the preceding netting interval.

13. The transaction hub according to claim 10, further including an input of additional netting parameters.

14. The transaction hub according to claim 13, wherein the additional netting parameters includes at least one counterparty trading limit.

15. The transaction hub according to claim 10, wherein the output of netted trades further includes a payment output.

16. The transaction hub according to claim 15, wherein the payments are netted.

17. The transaction hub according to claim 15, wherein the payments are collected by a central party.

18. The transaction hub according to claim 10, wherein the output of netted trades further includes a reconciliation output.
